(19) United States
(12) Patent Application Publication
(10) Pub. No.: US 2025/0296513 A1
(43) Pub. Date: Sep. 25, 2025

(54) VEHICLES WITH INTERIOR REAR STORAGE STRUCTURES WITH STORAGE PANELS

(71) Applicant: Toyota Motor Engineering & Manufacturing North America, Inc., Plano, TX (US)

(72) Inventor: Logan R. Astrike, Maysville, KY (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/615,190

(22) Filed: Mar. 25, 2024

(51) Int. Cl. B60R 7/04

(52) U.S. Cl. CPC B60R 7/043

(57) ABSTRACT

A vehicle includes a cabin including a front region including a front seat and a rear region that is located behind the front seat and extends to a rear wall of the cabin. A rear storage structure is located in the rear region of the cabin. The rear storage structure includes a rear glovebox storage bin including a glovebox lid that is configured to cover a rear glovebox storage volume in a closed configuration. The glovebox storage lid comprising a bumper structure that is mounted at an outer face of the glovebox storage lid.

### TECHNICAL FIELD

The present specification generally relates to storage structures vehicles and, more specifically, to interior rear storage structures for vehicles.

### BACKGROUND

Trucks, such as pickup trucks, often include both front seat assemblies and rear seat assemblies in their cabins. The front seat assemblies may be bucket-type seats that support a single person, for example, a driver or a single passenger. The rear seat assemblies may be bench-type seats that accommodate multiple passengers side-by-side. The vehicles may also include various storage structures within the cabin. For example, a front glove box is often provided that may be located at a passenger side of the vehicle that has a door that can be opened and closed. However, additional storage structures may be desirable.

Accordingly, a need exists for other interior storage structures within vehicles.

### SUMMARY

In one embodiment, a vehicle includes a cabin including a front region including a front seat and a rear region that is located behind the front seat and extends to a rear wall of the cabin. A rear storage structure is located in the rear region of the cabin. The rear storage structure includes a rear glovebox storage bin including a glovebox lid that is configured to cover a rear glovebox storage volume in a closed configuration. The glovebox storage lid comprising a bumper structure that is mounted at an outer face of the glovebox storage lid.

In another embodiment, a rear storage structure configured to be located in a rear region of a vehicle cabin includes a rear glovebox storage bin including a glovebox lid configured to cover a rear glovebox storage volume in a closed configuration. The glovebox storage lid includes a bumper structure that is mounted at an outer face of the glovebox storage lid.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a diagrammatic top view of a cabin of a vehicle including a rear storage structure, according to one or more embodiments shown and described herein;

FIG. 2 is a perspective view of a rear storage structure in a rear region of a cabin of a vehicle, according to one or more embodiments shown and described herein;

FIG. 3 shows the rear storage structure of FIG. 2 in isolation, according to one or more embodiments shown and described herein;

FIG. 4 is a diagrammatic section view of a bumper structure for use with the rear storage structure of FIG. 3, according to one or more embodiments shown and described herein;

FIG. 5 is a perspective view of the rear storage structure of FIG. 3 with a rear storage lid in an open configuration, according to one or more embodiments shown and described herein; and

FIG. 6 is a top view of the rear storage structure of FIG. 3 with a floor storage lid and a glovebox storage lid in open configurations, according to one or more embodiments shown and described herein.

### DETAILED DESCRIPTION

Embodiments described herein generally relate to vehicles, such as trucks, that include a cabin that includes a front region having a front seat and a rear region that is located behind the front seat and extends to a rear wall of the cabin. A rear storage structure is located in the rear region of the cabin. The rear storage structure includes a rear glovebox storage bin that includes a glovebox lid configured to cover a rear glovebox storage volume in a closed configuration, the glovebox lid comprising a bumper structure that is mounted at an outer face of the glovebox lid. The glovebox lid can pivot toward the rear wall of the cabin to an open configuration.

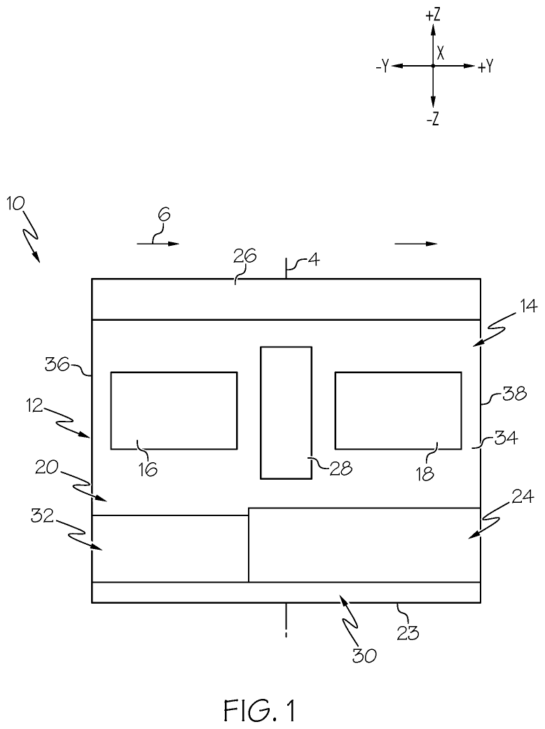

As used herein, the term “vehicle longitudinal direction” refers to the forward-rearward direction of the vehicle (i.e., in the +/−vehicle X-direction depicted in FIG. 1). The term “vehicle lateral direction” refers to the cross-vehicle direction (i.e., in the +/−vehicle Y-direction depicted in FIG. 1), and is transverse to the vehicle longitudinal direction. The term “vehicle vertical direction” refers to the upward-downward direction of the vehicle (i.e., in the +/−vehicle Z-direction depicted in FIG. 1). Further, the terms “inboard,” “inward,” “outboard” and “outward” are used to describe the relative positioning of various components of the vehicle. Referring to FIG. 1, the terms “outboard” or “outward” as used herein refers to the relative location of a component in direction 2 with respect to a vehicle centerline 4. The term “inboard” or “inward” as used herein refers to the relative location of a component in direction 6 with respect to the vehicle centerline 4. Because the vehicle structures may be generally symmetrical about the vehicle centerline 4, the direction to which use of terms “inboard,” “inward,” “outboard” and “outward” refer may be mirrored about the vehicle centerline 4 when evaluating components positioned along opposite sides of the vehicle 10.

Motor vehicles that incorporate elements according to the present disclosure may include a variety of construction methodologies that are conventionally known, including a unibody construction methodology as well as a body-on-frame construction methodology. It should be understood that vehicles that are constructed with body-on-frame or unibody construction may incorporate the elements that are shown and described herein.

While FIG. 1 depicts the vehicle 10 as a truck, it may be recognized that the vehicle 10 may be other vehicle types such as a sport-utility vehicle (SUV), and the like in various other embodiments. In FIG. 1, a cabin 12 of the vehicle 10 depicted diagrammatically and includes a front region 14 in which front seats 16 and 18 are located and a rear region 20 that extends rearward from the front region 14 to a rear wall 23 in which a rear storage structure 24 is located. The front seats 16 and 18 are located behind a dashboard 26. A center console 28 may be located between the front seats 16 and 18 and extends rearward from near the dashboard 26 toward the rear storage structure 24 located in the rear region 20 of the cabin 12. In this example, the vehicle 0 is a two-seat vehicle with the rear storage structure 24 located where rear seats might typically be expected.

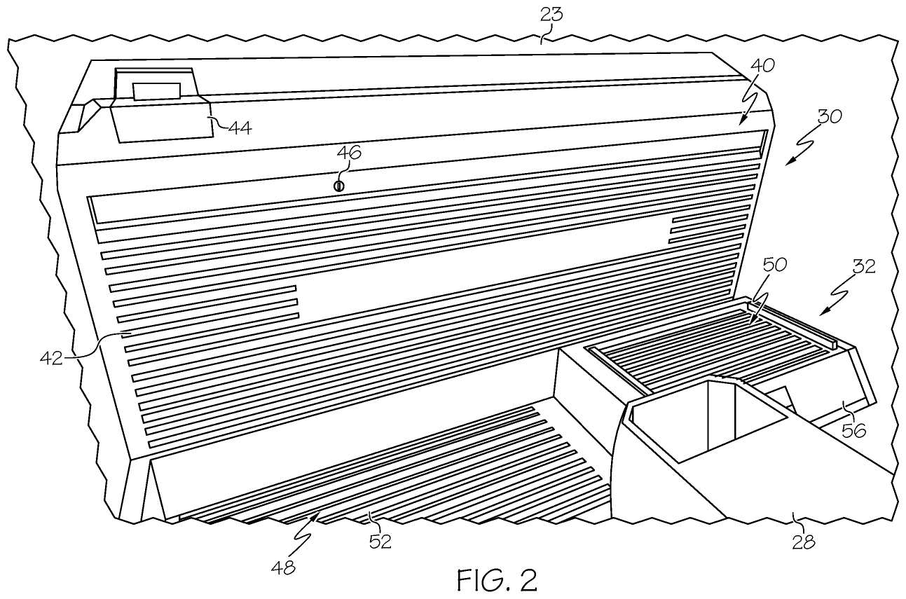

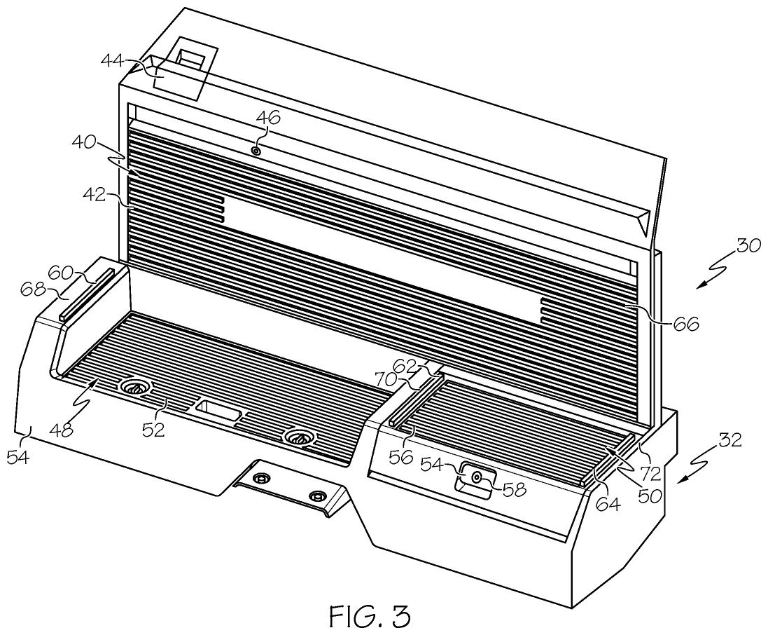

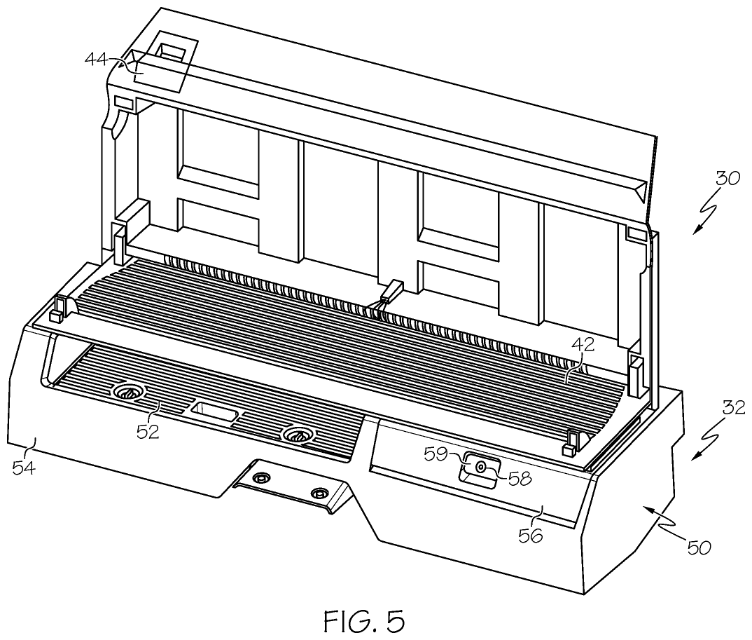

The rear storage structure 24 generally includes a vertical portion 30 that extends along the rear wall 23 and a horizontal portion 32 that extends along a floor 34 of the cabin 12. Referring to FIGS. 2 and 3, the vertical portion 30 extends in the vehicle vertical direction from the horizontal portion 32 and in the vehicle lateral direction between sidewalls 36 and 38 of the cabin 12 (FIG. 1). The vertical portion 30 may form, in some embodiments, a rear storage bin 40 at the rear wall 23 that includes a rear storage lid 42 that can be released using a lock device 44 (e.g., a latch) and moved from the illustrated closed configuration to an open configuration shown by FIG. 5. In some embodiments, the rear storage lid 42 may include a lock 46 that can be used to prevent opening of the rear storage lid 42 until opened, for example, using a key, code, sequence of numbers, etc. depending on the type of lock.

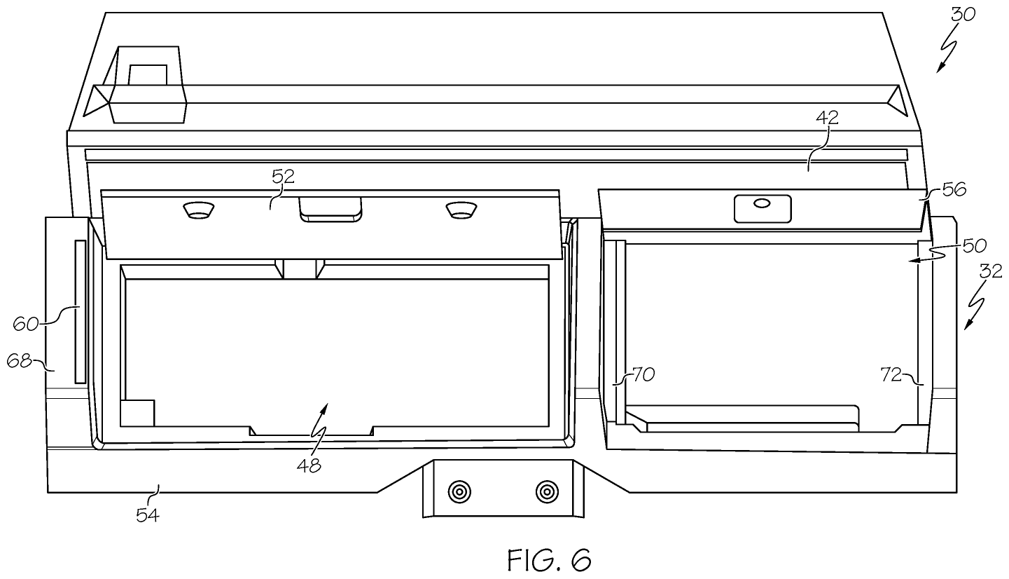

Referring still to FIGS. 2 and 3, the horizontal portion 32 of the storage structure 22 extends in the vehicle longitudinal direction outward from the vertical portion 30 and in the vehicle lateral direction between sidewalls 36 and 38. The horizontal portion 32 may include one or more storage bins, such as two storage bins 48 and 50 in the illustrated embodiment. While two storage bins 48 and 50 are shown, there may be one or more than two storage bins. Referring also to FIG. 6, the storage bin 48 may be a tool storage bin and the storage bin 50 may be a rear glovebox storage bin. For example, the tool storage bin 48 may be a location where various items can be stored, such as a hitch for use in towing a trailer and a jack for use in installing a spare tire. Various holding features may be provided in the tool storage bin 48 for holding such tools so that movement of the tools is limited when travelling. The tool storage bin 48 may include a floor storage lid 52 that can be moved from a closed configuration parallel to the floor 34 (FIGS. 2 and 3) to an open configuration (FIG. 5) at an angle, such as perpendicular, to the floor 34. The glovebox storage bin 50 may be a location where various items can be stored and also kept separate from items within the tool storage bin 48. For example, referring particularly to FIG. 3, the horizontal portion 32 may include the tool storage bin 48, which may be partially enclosed by an outer housing 54. The outer housing 54 at the tool storage bin 48 may be open at the bottom so that the items in the tool storage bin 48 are stored within the floor 34 of the cabin 12 (FIG. 1). The outer housing 54 at the glovebox storage bin 50 may be closed in that the outer housing 54, itself, forms a storage bin with the bottom closed. A glovebox lid 56 may be provided that can be moved from a closed configuration (FIG. 3) to an open configuration (FIG. 6). In some embodiments, the glovebox lid 56 may include a lock 58 that can be used to prevent opening of the glovebox lid 56 until opened, for example, using a key, code, sequence of numbers, etc. depending on the type of lock. The lock 58 may be provided on a latching device 59 that can be used to latch and release the glovebox lid 56 in the closed configuration.

Referring again to FIG. 3, as mentioned above, the rear storage lid 42 can be lowered from the illustrated closed position to the open position shown in FIG. 5 that is lowered upon the horizontal portion 32. In this regard, the horizontal portion 32 may include bumper structures 60, 62 and 64 that are provided a preselected locations to inhibit contact between a lid body 66 of the rear storage lid 42 and outer housing 54. In particular, the bumper structures 60, 62 and 64 are elongated in the vehicle longitudinal direction with the bumper structure 60 located at an outer ledge 68 of the outer housing 54. The bumper structures 62 and 64 are located at outermost edges 70 and 72 of the glovebox lid 56. As can be appreciated, as the rear storage lid 42 is lowered, the rear storage lid 42 encounters the bumper structures 60, 62 and 64, inhibiting further movement of the rear storage lid 42 into contact with the outer housing 54. The shape of the bumper structures 60, 62 and 64 allows for rotation of the rear storage lid 42, while also engaging over uneven surface features of the rear storage lid 42 in the open configuration. Further, in some embodiments, the glovebox lid 56 may be allowed to over stroke downward when moving to the closed configuration due to use of spring-loaded bumpers under the glovebox lid 56. In this regard, the bumper structures 62 and 64 may be angled or sloped downward along its length from front to back or back to front depending on the shapes of the lids 42 and 56.

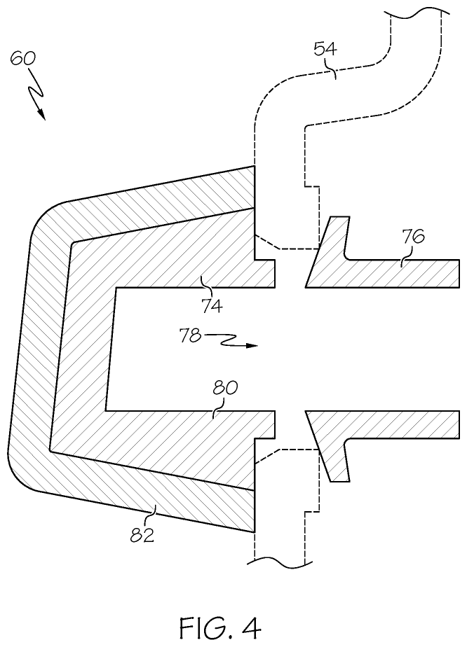

FIG. 4 shows a rotated section view of the bumper structure 60. Each of the other bumper structures 62 and 64 may include similar features. The bumper structure 60 may be a two-shot overmolded configuration that includes a harder substrate 74 (e.g., a polypropylene composite) that includes a mounting portion 76 that is sized to be inserted through an opening 78 in the outer housing 54 and an enlarged head portion 80 that extends outward from the mounting portion 76. A softer skin 82 (e.g., a rubber polymer) is overmolded about the head portion 80 of the substrate 74 forming a cushion for receiving the rear storage lid 42 in the open configuration (FIG. 6).

Referring now to FIG. 3 and also to FIG. 6, as mentioned above, the glovebox lid 56 can also be raised and lowered between the closed configuration (FIG. 3) and the open configuration (FIG. 6). The bumper structures 62 and 64 that are carried on the glovebox lid 56 can serve as stops for the rear storage lid 42 as described above with reference to FIG. 3 and described further with reference to FIG. 4. The bumper structures 62 and 64 can also inhibit over-rotation of the glovebox lid 56 when rotating the glovebox lid 56 to the open configuration as the bumper structures 62 and 64 can be sized and arranged such that they engage the rear storage lid 42 in the open configuration. Such as stopping arrangement for the bumper structures 62 and 64 can inhibit over-rotation rotation and hard contact between the glovebox lid 56 and the rear storage lid 42.

The above-described storage structures provide various storage locations within a rear region of vehicle cabins. The storage structures can include a vertical portion that extends along a rear wall of the vehicle cabins and a horizontal portion that extends along a floor of the vehicle cabins. The vertical portions can include a rear storage bin with a rear storage lid that can impede and allow access to the rear storage bin in closed and open configurations, respectively. The horizontal portions can include one or more storage bins, such as a floor storage bin that includes a floor storage lid that can impede and allow access to the floor storage bin in closed and open configurations, respectively, and a glovebox storage bin that includes a glovebox lid that can impede and allow access to the glovebox storage bin in closed and open configurations, respectively.

The various storage lids may be formed and arranged such that they open and close toward one another. To this end one or more bumper structures may be provided to provide a stop and a cushion for the storage lids in their open configurations against other storage lids. For example, as discussed above, the rear storage lid may be rotated to the open configuration where the rear storage lid rests upon the horizontal portions. In this open configuration, the rear storage lid can engage bumper structures that are carried by the horizontal portions. The rear storage lid may be used as a work area or for an additional storage area in the open configuration and the bumper structures can provided a barrier between the rear storage lid and the horizontal portions. Further, the glovebox storage lid may be provided with one or more bumper structures. The bumper structures of the glovebox lid can provide stops and inhibit over-rotation of the glovebox lid in the open configuration into the rear storage lid when rotating the glovebox storage lid to the open configuration.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A vehicle comprising:
a cabin comprising a front region comprising a front seat and a rear region that is located behind the front seat and extends to a rear wall of the cabin; and
a rear storage structure located in the rear region of the cabin, the rear storage structure comprising a rear glovebox storage bin including a glovebox lid configured to cover a rear glovebox storage volume in a closed configuration, the glovebox storage lid comprising a bumper structure that is mounted at an outer face of the glovebox storage lid.

2. The vehicle of claim 1, wherein the rear storage structure comprises a vertical portion that extends along the rear wall of the cabin and a horizontal portion that extends along a floor of the cabin.

3. The vehicle of claim 2, wherein the horizontal portion comprises the rear glovebox storage bin.

4. The vehicle of claim 3, wherein the horizontal portion comprises a tool storage bin that comprises a floor storage lid that is moveable between closed and open configurations.

5. The vehicle of claim 3, wherein the vertical portion comprises a rear storage bin that comprises a rear storage lid that is moveable between closed and open configurations.

6. The vehicle of claim 5, wherein the rear storage lid engages the bumper structure with the rear storage lid in the closed configuration.

7. The vehicle of claim 6, wherein the bumper structure is a first bumper structure, the rear storage structure comprises an outer housing that at least partially surrounds the glovebox storage bin and the tool storage bin, the outer housing comprising a second bumper structure located at an outer ledge of the outer housing that extends alongside the tool storage bin, the rear storage lid engaging the second bumper structure in the open configuration.

8. The vehicle of claim 7, wherein the first bumper structure extends along a first outermost edge of the glovebox storage lid, wherein a third bumper structure extends along an opposite, second outermost edge of the glovebox storage lid.

9. The vehicle of claim 8, wherein the first and third bumper structures are configured to engage the rear storage lid with the glovebox storage lid in the open configuration.

10. A rear storage structure configured to be located in a rear region of a vehicle cabin, the rear storage structure comprising:
a rear glovebox storage bin including a glovebox lid configured to cover a rear glovebox storage volume in a closed configuration, the glovebox storage lid comprising a bumper structure that is mounted at an outer face of the glovebox storage lid.

11. The rear storage structure of claim 10, wherein the rear storage structure comprises a vertical portion configured to extend along a rear wall of the vehicle cabin and a horizontal portion configured to extend along a floor of the vehicle cabin.

12. The rear storage structure of claim 11, wherein the horizontal portion comprises the rear glovebox storage bin.

13. The rear storage structure of claim 12, wherein the horizontal portion comprises a tool storage bin that comprises a floor storage lid that is moveable between closed and open configurations.

14. The rear storage structure of claim 12, wherein the vertical portion comprises a rear storage bin that comprises a rear storage lid that is moveable between closed and open configurations.

15. The rear storage structure of claim 14, wherein the rear storage lid engages the bumper structure with the rear storage lid in the closed configuration.

16. The rear storage structure of claim 15, wherein the bumper structure is a first bumper structure, the rear storage structure comprises an outer housing that at least partially surrounds the glovebox storage bin and the tool storage bin, the outer housing comprising a second bumper structure located at an outer ledge of the outer housing that extends alongside the tool storage bin, the rear storage lid engaging the second bumper structure in the open configuration.

17. The rear storage structure of claim 16, wherein the first bumper structure extends along a first outermost edge of the glovebox storage lid, wherein a third bumper structure extends along an opposite, second outermost edge of the glovebox storage lid.

18. The rear storage structure of claim 17, wherein the first and third bumper structures are configured to engage the rear storage lid with the glovebox storage lid in the open configuration.
